(19) United States
(12) Patent Application Publication
(10) Pub. No.: US 2008/0136819 A1
(43) Pub. Date: Jun. 12, 2008

(54) APPARATUS AND METHOD FOR SCREEN SCALING DISPLAYS ON COMMUNICATION DEVICES

(76) Inventors: Michael Shivas, Los Angeles, CA (US); John Krause, Calabasas, CA (US)

Correspondence Address: TOWNSEND AND TOWNSEND AND CREW LLP/EA, TWO EMBARCADERO CENTER, 8TH FLOOR, SAN FRANCISCO, CA, 94111, US

(21) Appl. No.: 11/609,212

(22) Filed: Dec. 11, 2006

(51) Int. Cl. G06T 17/00

(52) U.S. Cl. 345/428

(57) ABSTRACT

A communication device and method of screen scaling dissimilar resolutions across communication devices is disclosed. A communications device includes a physical display configured to display graphics having a physical display resolution, a communications interface configured to provide an interface with a peer communications device for graphics having a predetermined resolution different from the physical display resolution, and a processor configured to scale graphics between the physical display resolution required by the physical display and the predetermined resolution for the communications interface.

### BACKGROUND

1. Field

The present disclosure relates generally to communication devices, and more particularly, to the operation of a screen scaling system for communication devices.

2. Background

The demand for information services has led to the development of an ever-increasing number of communication devices with varying screen dimensions and resolutions. Basic Data Communication Devices (BDCDs) have a small-sized screen (typically between 120×120 or 240×240 pixels), menu or icon-based navigation via a thumb-wheel or cursor, and typically offer access to e-mail, address book, SMS, games and a basic web browser. Enhanced Data Communication Devices (EDCDs) have medium-sized to large-sized screens (normally greater than 240×240 pixels), and typically offer the same features as the BDCDs plus stylus-based navigation and the ability to run native applications such as communication versions of MS Office (e.g., Word, Excel, PowerPoint) and custom corporate applications such as mobilized versions of SAP, intranet portals, etc. Typical EDCDs include those running an operating system such as, for example, Windows Communication, PalmOS, and Symbian. Laptops, PCs, and all other communication devices capable of rendering images in high resolution (typically, above 640×480), offer the same display features as those contained in the BDCDs and EDCDs, however, this relationship is not reciprocated.

Although a high-resolution screen is capable of displaying any image that was created at a lower resolution, a low-resolution screen is incapable of displaying an image that was created on a high-resolution screen without severe degradation of picture quality or otherwise presenting a distorted image.

In general, a communication device capable of receiving display data may render the display data differently depending on the capabilities of the receiving device's screen. This is due, in part, to each communication device's physical display limitations. By way of example, a communication device user may initiate the transmission of display data on its screen. A receiving peer communication device, of differing screen dimension and/or resolution, receives and renders the transmitted display data onto its local screen. Because of the mismatch in screen resolution, the image is likely to be distorted in shape and/or color. Additionally, the rendered image will not be as sharp in quality as originally intended by the user of the transmitting communication device. This creates a problem when users are attempting to exchange images that are sensitive to quality and exact representation as originally intended by the transmitting user. Thus, there is a need for a system that ensures the accurate depiction of a graphic between devices of dissimilar resolutions upon transmission.

### SUMMARY

One aspect of a communication device is disclosed. A communications device includes a physical display configured to display graphics having a physical display resolution, a communications interface configured to provide an interface with a peer communications device for graphics having a predetermined resolution different from the physical display resolution, and a processor configured to scale graphics between the physical display resolution required by the physical display and the predetermined resolution for the communications interface.

One aspect of a method for scaling graphics on a communications device with a physical display is also disclosed. The method includes displaying graphics having a physical display resolution on the physical display, providing an interface with a peer communications device for graphics having a predetermined resolution different from the physical display resolution, and scaling graphics between the resolution of the physical display and the predetermined resolution.

One aspect of a method for scaling graphics between a plurality of communication devices with physical displays is also disclosed. The method includes displaying graphics on a transmitting communication device's physical display, scaling graphics from the resolution of the transmitting communication device's physical display to a virtual display resolution, transmitting the scaled graphics having the virtual display resolution to a receiving communication device, receiving the scaled graphics on the receiving communication device, scaling the previously received graphics from the virtual display resolution to the receiving communication device's physical display resolution, and displaying graphics on the receiving communication device's physical display.

Another aspect of a communication device is disclosed. The communications device includes a means for displaying graphics having a physical display resolution on the physical display, means for providing an interface for graphics having a predetermined resolution different from the physical display resolution with a peer communications device, and means for scaling the graphics between the resolution of the physical display and the predetermined resolution.

An aspect of a computer readable medium is disclosed. A computer readable medium embodying a program of instructions executable by a processor in a communications device including a physical display configured to display graphics having a physical display resolution and a communications interface configured to provide an interface for the graphics having a predetermined resolution different from the physical display resolution with a peer communications device, the program of instructions comprising code to scale the graphics between the resolution of the physical display and the predetermined resolution.

### BRIEF DESCRIPTION OF THE DRAWINGS

Aspects of the present invention are illustrated by way of example, and not by way of limitation, in the accompanying drawings wherein:

FIG. 1 is a conceptual block diagram illustrating a multiple communication device layout for the screen scaling system;

FIG. 2 is an example of a hardware configuration for the software-based screen scaling system of FIG. 1; and

FIG. 3 is a flow chart of an embodiment of a communication device screen scaling system.

### DETAILED DESCRIPTION

The detailed description set forth below in connection with the appended drawings are intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well-known structures and components are shown in block diagram form in order to avoid obscuring the concepts of the invention.

In the following detailed description, various concepts will be described in the context of a physical display or screen for communication devices. These communication devices may include BDCDs, EDCDs, and other similar technologies embodied in mobile telephones, personal digital assistants (PDA), laptop computers, personal computers (PC), game consoles, or other suitable devices capable of transmitting and/or receiving graphics. As used herein, a “graphic” means any visual representation such as an illustration, drawing, design, diagram, figure, picture, photo, pattern, text, or any other image capable of being presented to a physical display or screen on a communications device. These graphics may be transmitted between communication devices having different screen resolutions in a way that is transparent to the users.

The communication device may include a user interface that is menu driven by on-screen or keypad options. From the options available, the user can select to input graphic features (i.e. lines, circles, colors, etc.) in order to compose a graphic rendered on the local physical display or screen. Once the graphic is displayed to the user, various selections may be presented to the user in a sub-menu or prompt format. By way of example, a user can choose to add additional graphic features, delete varying graphic features, access various tools, and perform many other similar functions. The communication device may be configured such that the user can make a menu selection to transmit or otherwise communicate the graphic to a peer communication device. Prior to transmission, the resolution of the graphic is scaled to a predetermined resolution. The predetermined resolution is generally compatible with a virtual display. A “virtual display” is a conceptual display that is common to multiple communication devices in a network. It is a specification that requires all communication devices in the network to exchange graphics at a predetermined common resolution. This predetermined common resolution is sparingly referred to herein as the “virtual display resolution.” As long as the virtual display resolution is equal or greater than the resolution of the physical display for communications device with the highest resolution, the graphics may be exchanged between all communication devices within the network and displayed on different screen sizes with minimum distortion. Each communication device handles the conversion between the physical display resolution and the virtual display resolution internally.

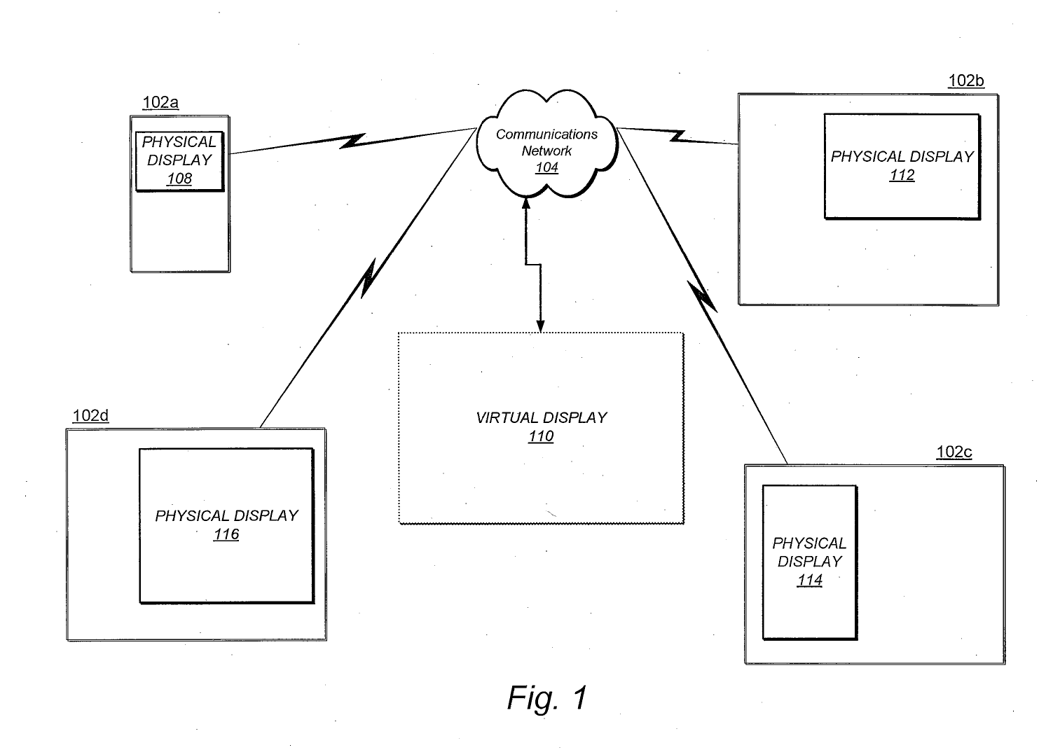

FIG. 1 is a conceptual block diagram illustrating a multiple communication device layout for the screen scaling system. A virtual display 110 provides a conceptual termination for all graphics transmitted by each of the communication devices 102a-102d. The virtual display 110 also provides a conceptual source for all graphic transmissions received by each of the communication devices 102a-102d. The virtual display 110 may be any resolution so long as it is fixed among participating communication devices, however, minimum distortion may be achieved with a virtual display resolution that is equal to or greater than the physical display on the communications device with the highest resolution. The physical displays 108, 112, 114, 116 may be of dissimilar resolution when fixed upon communication devices 102a-102d. Each communication device 102a-102d communicates with a peer communication device 102a-102d over a communications network 104.

The communications network 104 represents any suitable means for connecting the communication devices 102a-102d. By way of example, the communications network 104 may be implemented using infrared, Bluetooth, Ultra Wide-Band (UWB), or other similar type of wireless connectivity. Alternatively, the communications network 104 may be a GPRS connection which is common among GPS mobile telephones, or a packet-based or circuit switched network with a wired or wireless connection. The wired connection may be PSTN, DSL, cable modem, fiber optic, Ethernet, or the like. The wireless connection may be 3G, Wi-Fi, Wi-Max, or any other suitable wireless interface. The packet-based network may be a Internet, an intranet, a private Internet Protocol (IP) network, or the like.

Due to low-bandwidth limitations typically found in some communication networks, the amount of data transmitted may be minimized by compressing the graphics before transmission. By way of example, compressed graphics may comprise geometrical primitive graphics (i.e. vector graphics or similarly size efficient graphical data), or any other graphic representations in a vector space. Geometrical primitives specify the coordinates of shapes, as well as the color of each shape. Because these coordinates are relatively small in comparison to a pixel-by-pixel representation of the graphic, it allows for ease of transmission over low-bandwidth restrictions. In addition, geometrical primitives allow graphics to be scalable due to their vector composition, however, one of ordinary skill in the art would appreciate that the scalability of graphics is not contingent on the graphics being previously compressed. Due to the scale processing system, a graphic displayed on physical display 108, 112, 114, 116 will be rendered on physical display 108, 112, 114, 116 with unprecedented precision and accuracy. Further, a color-averaging algorithm may be used to create a more aesthetically pleasing image when reducing the resolution of the graphics. The color-averaging algorithm may be implemented by using cubic interpolation, linear interpolation, or any other suitable method known in the art.

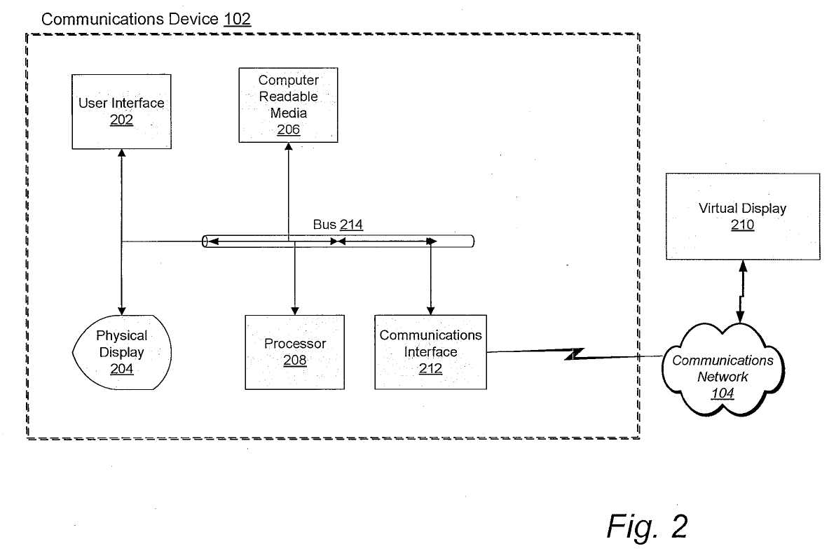

FIG. 2 is a conceptual block diagram of a communications device. The communication device 102 may be implemented with a number of components connected by a bus 214. A processor 208 may be used to provide graphical scaling between a physical display 204 and a virtual display 210. The processor 208 may be implemented as individual or shared hardware components, as software applications running on one or more hardware components, or any combination thereof. By way of example, the processor 208 may be implemented with a microprocessor that supports multiple software applications. The processor 208 may include one or more other components, either alone or in combination with a microprocessor. These other component may include a Digital Signal Processor (DSP), an Application Specific Integrated Circuit (ASIC), Field Programmable Gate Array (FPGA), Programmable Logic Array (PLA), Programmable Logic Device (PLD), discrete gate or transistor logic, or any combination thereof. Those skilled in the art will recognize the interchangeability of hardware, firmware, and software configurations in these communication devices, and how best to implement the described functionality for each particular application.

The communications device 102 also includes a computer-readable medium 206. The computer-readable medium 206 may include one or more storage devices coupled to the bus 214 accessible by the processor 208. The storage devices may include RAM memory, flash memory, ROM memory, EPROM memory, EEPROM memory, registers, hard disk, a removable disk, a CD-ROM, DVD, or any other form of storage medium known in the art. Alternatively, the computer-readable medium 206 may be, in whole or part, integral to the processor 208. Computer-readable medium 206 may also encompass a carrier wave that encodes a data signal.

The communications device 102 may also include a communications interface 212 connected to the bus 214. The communications interface 212 is shown in FIG. 2 connected to a communications network 104. In at least one embodiment of the communications device 102, the communications network 104 is capable of supporting transmission of low-bandwidth vector graphics or, equally, high-bandwidth raster graphics. The communications interface 212 is shown in communication with a single communications network 104, but the communications interface 212 may be implemented to communicate with one or more networks, limited only by accessibility.

The processor 208 may be coupled through the bus 214 to a user interface 202. The user interface 202 may also include a number of input devices, such as a keypad, touchpad, stylus, touch screen, and a cursor control for communicating with the processor 208 and controlling cursor movement on a physical display 204. The physical display 204 may be a liquid crystal display (LCD) or any other suitable display.

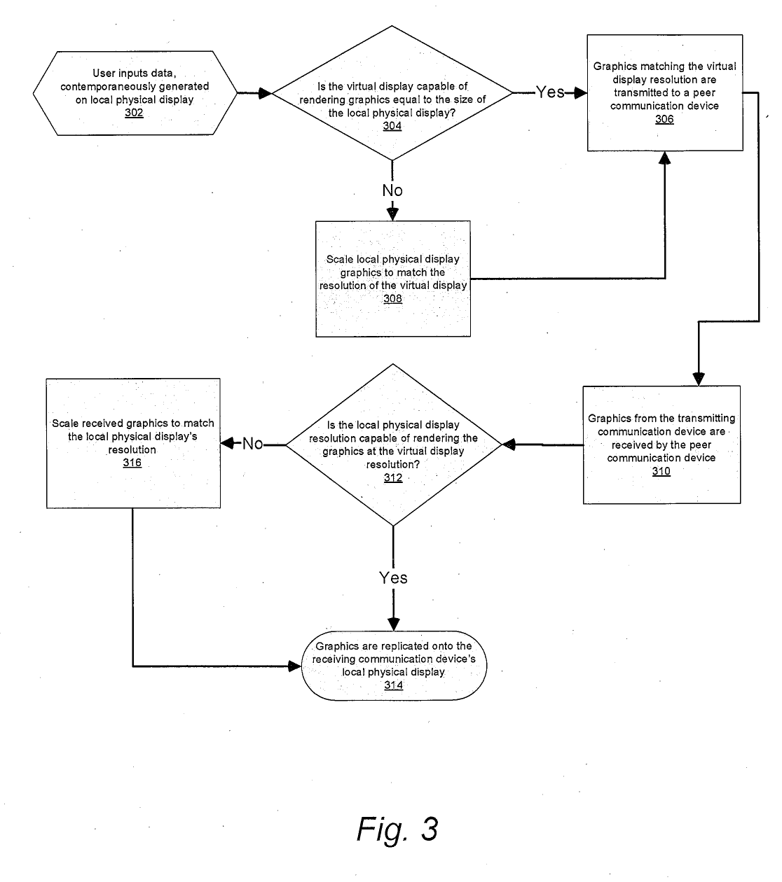

FIG. 3 is a flow chart illustrating the functionality of two communication devices. Referring to FIGS. 2 and 3, a user on a transmitting communication device 102 inputs data via the user interface 202 in step 302. The data that the user input is managed by the processor 208 and is contemporaneously displayed on the local physical display 204 in the form of graphics. In step 304, the processor 208 determines whether the virtual display 210 is capable of rendering graphics equal to the size of the local physical display 204. The transmitting communication device 102 may have a large enough physical display 204 that renders performing the scaling process moot, and in such case, the process will enter step 306. Otherwise, in step 308, the graphics on the local physical display 204 will be scaled to match the resolution of the virtual display 210. The resolution of the virtual display 210 will be common among all peer communication devices 102 participating in the screen scaling system, thereby eliminating the possibility of graphical misrepresentations on peer communication devices 102. Once the graphics are scaled the process enters step 306. In step 306, the graphic is transmitted to a peer communication device 102 via the communications interface 212 of the communication device 102 and across a communications network 104.

The graphics from the transmitting communication device 102 are received by the receiving communication device 102 in step 310. In step 312, the processor 208 determines whether the local physical display 204 is capable of rendering an image equal to the size of the virtual display 210. The process enters step 316 in situations where dissimilar resolutions between the physical display 204 and the virtual display 210 exist. In step 316, the graphics received from the transmitting communications device 102 will be scaled to match the resolution capability of the local physical display 204. Step 316 is bypassed if the physical display 204 is capable of displaying graphics with the resolution equal to the resolution of the virtual display 210. In step 314, the graphics, either scaled pursuant to step 316 or not, are replicated onto the receiving communication device's 102 physical display 204.

The functionality of two communication devices is described with reference to FIG. 3 to illustrate the virtual display concept. Those skilled in the art will readily understand that one or more steps described in FIG. 3 may be omitted and/or altered depending upon the specific application and the overall design constraints imposed on the overall system. By way of example, the processor 208 does not necessarily have to determine whether the local physical display 204 has the same resolution as the virtual display every time a user inputs data on the user interface 202. This step may be performed only when the resolution of the virtual display is changed through programming or some other means. In screen scaling systems where the predetermined resolution of the virtual display is fixed, this step may be eliminated in its entirety. The processor 208 in communication devices 102 having a physical display resolution that is different from the predetermined resolution of virtual display simply performs scaling on all graphics to be transmitted over the communications network 104. A processor 208 in a communications device 102 having a physical display resolution that is the same as the predetermined virtual display resolution can simply transmit graphics without any scaling.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language of the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A communications device, comprising:
a physical display configured to display graphics having a physical display resolution;
a communications interface configured to provide an interface with a peer communications device for graphics having a predetermined resolution different from the physical display resolution; and
a processor configured to scale graphics between the physical display resolution required by the physical display and the predetermined resolution for the communications interface.

2. The communications device of claim 1 wherein the processor is further configured to scale the graphics displayed on the physical display from the physical display resolution to the predetermined resolution, and the communications interface is configured to interface with the peer communications device by transmitting the scaled graphics.

3. The communications device of claim 2 further comprising a user interface, the physical display being further configured to display the graphics in response to input from the user interface.

4. The communications device of claim 1 wherein the communications interface is configured to interface with the peer communications device by receiving the graphics, and the processor is further configured to scale the graphics received by the communications interface from the predetermined resolution to the physical display resolution for displaying on the physical display.

5. The communications device of claim 1 wherein the predetermined resolution is greater than or equal to the physical display resolution.

6. The communications device of claim 1 wherein the predetermined resolution is programmable.

7. The communications device of claim 1 wherein the graphics having the predetermined resolution comprises geometrical primitive data.

8. The communications device of claim 1 wherein the communications interface is further configured to provide an interface with the peer communications device over a wireless medium.

9. A method of scaling graphics on a communications device with a physical display, the method comprising:
displaying graphics having a physical display resolution on the physical display;
providing an interface with a peer communications device for graphics having a predetermined resolution different from the physical display resolution; and
scaling graphics between the resolution of the physical display and the predetermined resolution.

10. The method of claim 9 wherein the graphics displayed on the physical display are scaled from the physical display resolution to the predetermined resolution and the interface for the graphics is provided by transmitting the scaled graphics to the peer communications device.

11. The method of claim 10 wherein the graphics are displayed in response to user input to the communications device.

12. The method of claim 9 wherein the interface for the graphics is provided by receiving the graphics from the peer communications device, and the received graphics are scaled from the predetermined resolution to the physical display resolution for displaying on the physical display.

13. The method of claim 9 wherein the predetermined resolution is greater than or equal to the physical display resolution.

14. The method of claim 9 further comprising converting the graphics between pixel data having the physical display resolution and geometrical primitive data having the predetermined resolution.

15. The method of claim 9 wherein the interface for the graphics is provided over a wireless medium.

16. A method of scaling graphics between a plurality of communication devices with physical displays, the method comprising:
displaying graphics on a transmitting communication device's physical display;
scaling graphics from the resolution of the transmitting communication device's physical display to a virtual display resolution;
transmitting the scaled graphics having the virtual display resolution to a receiving communication device;
receiving the scaled graphics on the receiving communication device;
scaling the previously received graphics from the virtual display resolution to the receiving communication device's physical display resolution; and
displaying graphics on the receiving communication device's physical display.

17. A communications device, comprising:
means for displaying graphics having a physical display resolution on the physical display;
means for providing an interface for graphics having a predetermined resolution with a peer communication device; and
means for scaling the graphics between the resolution of the physical display and the predetermined resolution different from the physical display resolution.

18. The communications device of claim 16 wherein the means for scaling the graphics comprises means for scaling the displayed from the physical display resolution to the predetermined resolution, and the means for providing an interface for the graphics comprises means for transmitting the scaled graphics to the peer communication device.

19. The communications device of claim 16 wherein the means for providing an interface for the graphics comprises means for receiving the graphics from the peer communications device, and the means for scaling the graphics comprises means for scaling the received graphics from the predetermined resolution to the physical display resolution for display.

20. A computer readable medium embodying a program of instructions executable by a processor in a communications device including a physical display configured to display graphics having a physical display resolution and a communications interface configured to provide an interface for the graphics having a predetermined resolution different from the physical display resolution with a peer communications device, the program of instructions comprising code to scale the graphics between the resolution of the physical display and the predetermined resolution.

21. The computer readable medium of claim 19 wherein the code scales the graphics displayed on the physical display from the physical display resolution to the predetermined resolution for transmission to the peer communications device by the communications interface.

22. The computer readable medium of claim 19 wherein the code scales the graphics received by the communications interface from the predetermined resolution to the physical display resolution for display on the physical display.

23. The computer readable medium of claim 19 wherein the predetermined resolution is greater than or equal to the physical display resolution.

24. The computer readable medium of claim 19 further comprising code to convert the graphics between pixel data having the physical display resolution and geometrical primitive data having the predetermined resolution.
